(19) United States
(12) Patent Application Publication
(10) Pub. No.: US 2013/0191383 A1
(43) Pub. Date: Jul. 25, 2013

(54) Method for digitally recording information

(71) Applicant: Keat Jin Lee, Guilford, CT (US)

(72) Inventor: Keat Jin Lee, Guilford, CT (US)

(21) Appl. No.: 13/573,639

(22) Filed: Sep. 28, 2012

Related U.S. Application Data
(63) Continuation-in-part of application No. 12/718,102, filed on Mar. 5, 2010, now abandoned.
Application No. 12/718,102 is a continuation-in-part of application No. 12/326,434, filed on Dec. 2, 2008, now abandoned.

(51) Int. Cl. G06F 17/30

(52) U.S. Cl. CPC G06F 17/30289
USPC 707/736

(57) ABSTRACT

In a system and computer implemented method for digitally recording progress notes a content database is operable with a computing device to populate information relevant to patients and care providers. Selected items are displayed on a screen of a computing device. The computing device operates to generate information mandated by one or more certifying authorities by causing questions pertaining to the mandated information and selectable answers to the questions to be exhibited on a display of the computing device. At least a portion of the questions displayed are dependent on the answers chosen by the user during operation of the computing device. The selected answers are stored into the content database.

### CROSS REFERENCE

This application is related to and claims the benefit of U.S. patent application Ser. No. 12/718,102, entitled “Method for Digitally Recording Information,” filed on Mar. 5, 2010, which in turn claims priority to U.S. patent application Ser. No. 12/326,434 entitled “Method for Digitally Recording Progress Notes,” filed on Dec. 2, 2008. The disclosure of these US patent documents are incorporated by reference herein in their entireties.

### FIELD OF THE INVENTION

The present invention is generally related to a system and method for digitally gathering, creating and recording information and, more specifically, is directed to a system and computer implemented method for gathering, creating and recording information mandated by a certifying body.

### BACKGROUND

During the course of a medical interview and/or examination, one or more health care providers generally record a significant amount of information. This record is generally referred to as “Progress Notes” or “History and Physical.” Typically this is accomplished via handwritten notes which must later be transcribed by administrative personnel (e.g. a secretary or medical transcriptionist). This involves time, extra cost and provides for the introduction of human error. Moreover, having to handwrite notes requires the health care provider to spend time that could otherwise be spent with a patient, it also requires the health care provider to carry and return paper files. In addition, following the interview and/or examination, the health care provider often sends a letter to a patient, insurance company or to another health care provider (e.g. a referral letter). These letters have historically been written, typed, or dictated. In the case of handwritten or dictated letters, they must then be transcribed and forwarded to the appropriate recipient. All of this adds to the cost and expense associated with the patient's visit. Moreover, there is currently no uniform, standard method for taking and recording patient information.

Electronic Medical Record (EMR) systems have recently become subject to certification by government recognized certifying authorities. In order for an EMR system to qualify for certification, it should be functional to provide certain information as directed by the certifying organization and/or the government. Depending on the type and specialty of the health care provider that a patient is seeing, the information required to be entered into the EMR system may be unrelated to the particular specialty.

For example, a patient may be seeing a podiatrist and the information required to be entered in order for the EMR system to be certified may relate to whether the patient wears glasses. Having to enter such unrelated information is time consuming and therefore reduces either the time a health care provider sees a patient, or the number of patients the health care provider can see. This in turn reduces the profitability of the provider's practice and increases the amount of time that a patient must wait to see the health care provider.

### SUMMARY OF THE INVENTION

The present invention resides in one aspect in a computer implemented method for digitally recording progress notes. The method comprises establishing a content database operable with a computing device, the content database being populable with identifying information relevant to particular patients and care providers. The computing device exhibits interfaces customizable by a user such that the user can input items to be exhibited on a display of a computing device. The items are choosable by the user. The computing device is further customizable to exhibit, on the screen, questions to be answered and the allowable answers to the questions. The questions and selectable answers can be input by a user so that the computing device is operable to exhibit them in accordance with choices made by the same or another user during an interview and/or examination. The computing device is operable to allow the user to enter text to be input into a form letter, the text to be input into the form letter being dependant, at least in part, on the allowable answers chosen by a user. The text to be input can be customized and be made dependant on the answers input into the computing device in response to the questions exhibited thereon. The computing device can also be operable with the content database to allow a user to manually enter progress notes.

The present invention also resides in a computer implemented method for quickly and efficiently, within an electronic medical record system, entering information required by an EMR certifying authority related to individual patients. The information required by the certifying authority is programmed into a computing device so that the information can be exhibited thereon. During a patient interview wherein the above-described information is being entered by a health care provider or by the patient (hereinafter referred to as the “user”) the user selects a category displayed in the computing device, such as, for example, general information. The user is then presented with one or more selectable items, such as, but not limited to, “Does the patient smoke,” or “has the patient recently lost weight.” Choosing one of these items then results in additional selectable items being exhibited by the computing device. These additional items present the user with choices to select from based on answers elicited from the patient. For example, in response to selecting, “Does the patient smoke” the user could be presented with selectable item indicating a “yes” or “no” response. If “no” is selected then the user can move on to the next category of information, such as, for example, “has the patient recently lost weight.” If the item indicating “yes” is selected then another series of selectable items indicative of a patient's response may be exhibited. For example, selectable items indicating the number of packs of cigarettes a patient smokes per day may be displayed. Once selected the information corresponding to the selected item is stored in the patient's medical records. The computing device can also provide for a user being able to add notes to further describe or clarify a selection. These notes can be typed into the computing device, written by hand such as would be done using an electronic tablet, or tablet-type computing device. The notes may also be recorded into the computing device.

Where the computing device is a tablet or tablet-type device, a scrolling feature is integrated into interfaces to allow the selectable information to be scrolled through quickly using a system, touch pad, or a user's finger.

### BRIEF DESCRIPTION OF THE DRAWINGS

FIG. 1 is a simplified schematic block diagram of an information system providing enhanced management of patient care, in accordance with one embodiment of the present invention;

FIG. 2 is a simplified flow diagram outlining a patient interaction process, in accordance with one embodiment of the present invention;

FIG. 3 is a simplified schematic block diagram of the information system of FIG. 1 operating during a patient interview step, in accordance with one embodiment of the present invention;

FIG. 4 is a simplified schematic block diagram of the information system of FIG. 1 operating during a patient examination step, in accordance with one embodiment of the present invention; and

FIG. 5 is a simplified schematic block diagram of the information system of FIG. 1 operating during a patient disposition step, in accordance with one embodiment of the present invention.

### DETAILED DESCRIPTION OF THE PREFERRED EMBODIMENTS

The present invention is directed to a system and a computer implemented method for digitally gathering, creating and recording information including progress notes when evaluating different situations. The method is described in connection with a health care provider such as, for example, a doctor or a nurse, that gathers, creates and records information including progress notes during a patient interview or examination. However, the present invention is not limited in this regard as utility can be found in other areas such as, for example, an engineering project, or quality control setting. In addition, this method can be implemented as a stand-alone software application executing in a computing device, a feature or function of another software application executing in the computing device or an add-on feature or function of an existing software application executing in the computing device.

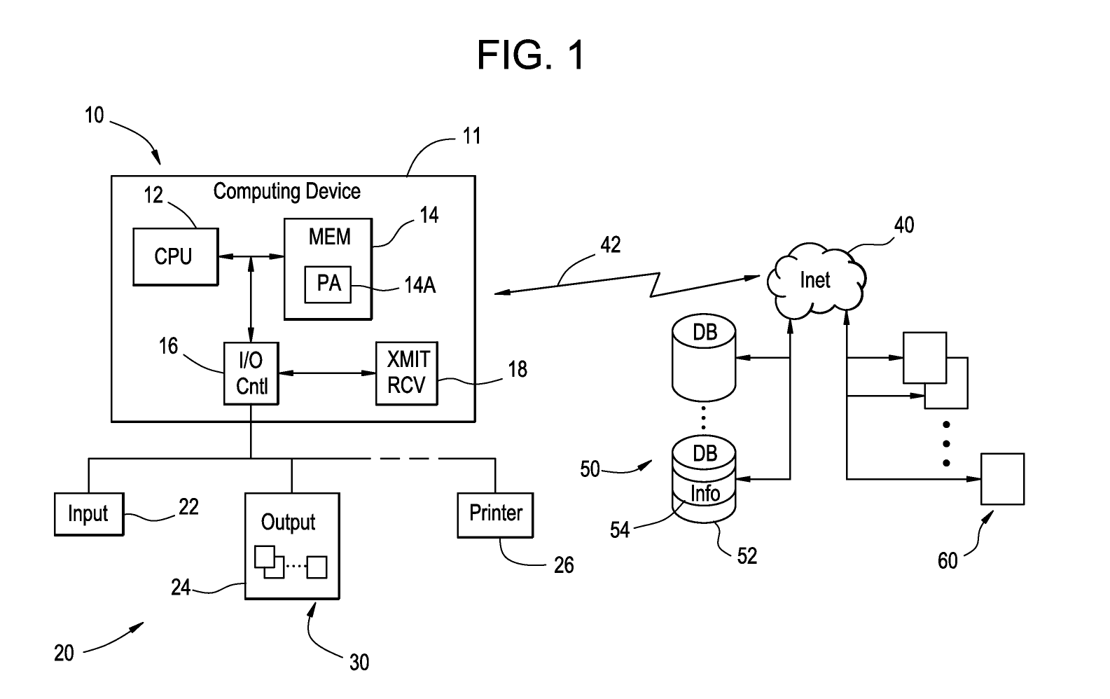

As shown in FIG. 1, an information system 10 is configured and operates in accordance with one embodiment of the present invention to implement techniques, as described herein, for gathering, collecting, creating, storing, recording, computing, displaying and distributing information including progress notes when evaluating different situations. As shown in FIG. 1, the information system 10 includes a computing device 11 including a processor such as a microprocessor or CPU 12, computer-readable medium or memory 14, an input-output controller 16 operatively coupled to input and output devices, shown generally at 20, including an input device 22 for facilitating input of data and information to the computing device 11 such as a keyboard, a mouse, light pen pointing device, document scanner, audio and/or video recorder or other input device, and output devices for displaying inputted and/or processed data and other information such as a pixel-oriented display device 24, printer 26 or the like. In one embodiment, the computing device 11 includes a transceiver 18 operatively coupled to a communications network 40 such as the Internet, an intranet, an extranet, or like distributed communication platform for accessing one or more storage devices 50 and/or sending and receiving data, information, commands, and otherwise communicating with one or more external devices 60 over wired and wireless communication connections 42. In one embodiment, the storage devices 50 include a content database 52 storing records 54 including patient data and information as described herein.

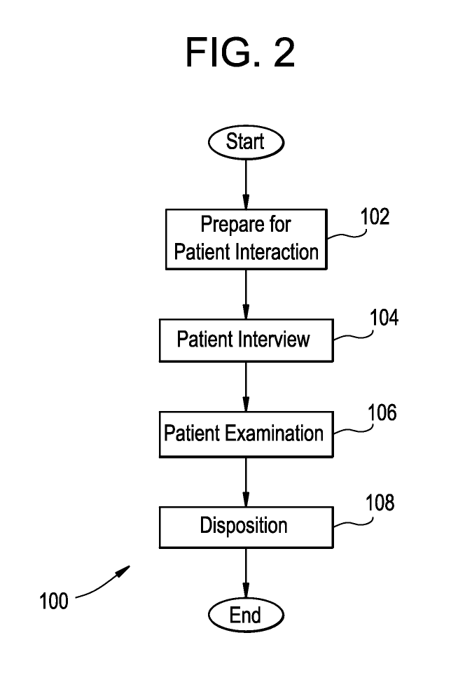

Generally speaking, the information system 10 is employed by a health care provider performing one or more steps before, during and after the health care provider interacts with a patient. As shown in FIG. 2, a flow 100 of patient interaction includes, in accordance with one embodiment of the invention, a step 102 wherein a health care provider and/or personnel at an office of the health care provider prepares for a schedule appointment a patient has with the health care provider. This preparation step 102 may include retrieving records 54 including data and information regarding the patient stored in the content database 52. During a patient interview step 104, the health care provider using the computing device 11 embodied as, for example, a portable computer, personal digital assistant (PDA), tablet, or the like, executes computer-implemented steps including Provider Assistance (PA) methods 14A stored in the memory 14 such that a health care provider (e.g., physician, nurse or the like) operating the system 10 may invoke and execute the PA methods 14A, input and review data and information exhibited on the display device 24 and make decisions regarding, for example, a disposition of the patient as described in further detail below. In one embodiment, the PA methods 14A include, for example, a uniform and customizable method for gathering and recording patient information. It should be appreciated that the computer-implemented PA methods 14A generally require manipulation of data and information in the form of electrical, magnetic and/or optical signals that may be inputted, stored, transferred, combined, compared, or otherwise manipulated to provide a desired result. In one embodiment, a desired result includes visual representations of one or more data and information including progress notes when evaluating different situations such as, for example in the illustrated embodiment, managing and/or providing health care to a patient.

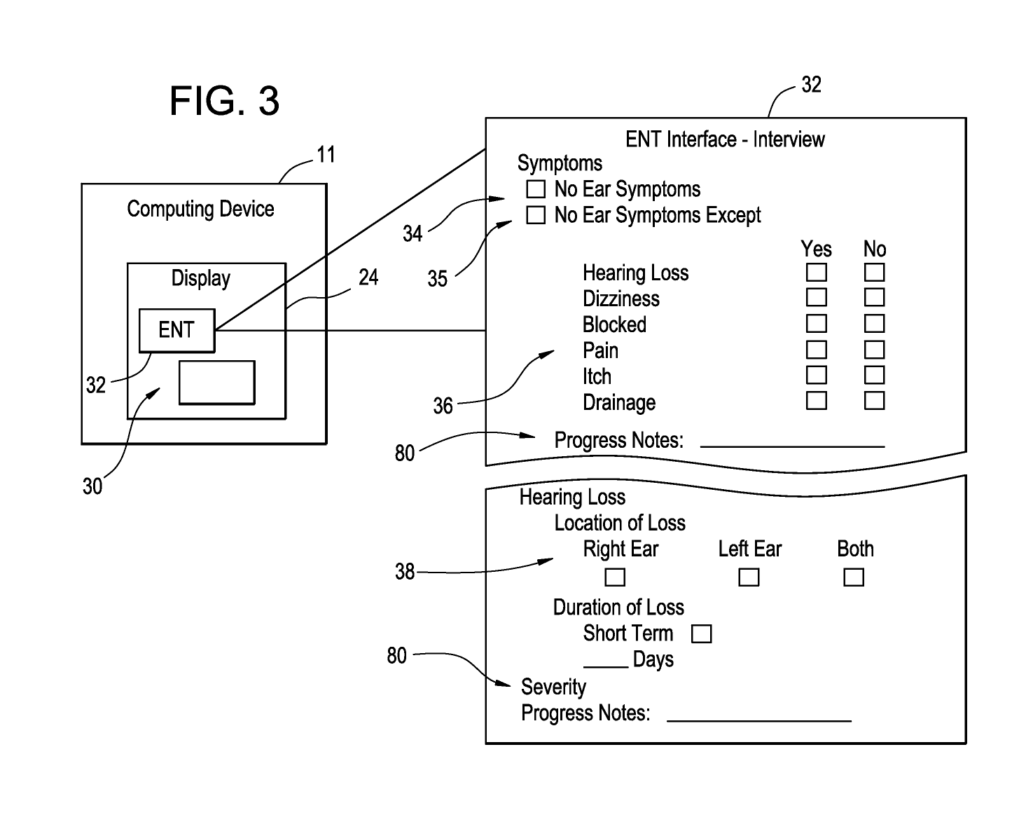

For example, the PA methods 14A may direct the processor 12, input-output controller 16 and display 24 to exhibit one or more user interfaces, e.g., application generated user interfaces, web pages, and the like, shown generally at 30, for evaluating one or more symptoms of the patient. In one embodiment, the health care provider may, from an introductory interface, choose one of a variety of medical specialties appearing on the display device 24. For example, the health care provider may in the course of an interview (e.g., at Step 104) or examination (e.g., Step 106 described below), wish to evaluate a patient's ears and/or hearing. As such, the health care provider chooses the appropriate medical specialty, for example, an ENT interface—Interview 32 (FIG. 3). As described herein the ENT interface 32, as well as other interfaces 30 designed for other medical specialties and/or customized by one or more health care providers and/or offices of one or more providers, directs the health care provider in digitally gathering, creating and recording data and information including progress notes when evaluating and performing one or more steps (e.g., the method 100) before, during and after the health care provider interacts with the patient. As shown in FIG. 3, the ENT interface 32 includes a plurality of inquires 34 such as, for example, inquiries as to one or more symptoms being experienced by the patient. For example, the inquiries 34 may include such things as “No Ear Symptoms,” and “No Ear Symptoms Except” items. Choosing “No Ear Symptoms” (e.g., by selecting a check box 35 or like selection indicator, ends the evaluation of the patient's ears. However, selecting “No Symptoms Except” leads the health care provider to a further interface or menu display 36 (e.g., on the same interface 34 or by invoking a new interface) of symptoms from which the health care provider can choose “yes” or “no” for each symptom. For example, with respect to a patient's ears, the interface 36 lists symptoms to choose from and can include, for example, hearing loss, dizziness, blocked, pain, itch, drainage and the like. Choosing “no” to any one of these symptoms would end further inquiry with respect to that symptom. This could cause the particular symptom to be removed from the display. Choosing “yes” with respect to the particular symptom leads the health care provider to a still further interface or menu display 38 (e.g., on the same interface 34 or by invoking a new interface) in which the provider inputs one or more additional data and information regarding that symptom by, for example, answering questions aimed at further exploring the patient's condition. In one embodiment, standardized answers may be chosen from selectable items on the interface 38.

Assuming for sake of description, one of the symptoms the patient exhibits is hearing loss. Choosing the hearing loss item on the interface 36 invokes the interface 38 where another menu of choices is exhibited on the display 24 of the computing device 11. For example, the health care provider can choose an item on the interface 38 that corresponds to a location of the hearing loss, for example, whether the hearing loss is in the right ear, the left ear, or both ears. This choice then can lead to another series of choices such as the duration of the symptoms, the severity of the symptoms, etc. The process of each choice leading to the ability to select from another series of choices can continue until such time as the symptom has been sufficiently explored. As can be appreciated, data and information may be inputted in a number of different manners, for example, by selecting one or more predetermined answers, by free form textual input of data and information, and the like. For example, during the above-described process, the system 10 is operable to allow the health care provider to digitally record progress notes. These progress notes can take the form of one or more of typed text, in the case of a tablet and some PDA's that can accommodate it, written text, ink technology, video recordings, audio recordings, and combinations thereof. The system 10 can also be operable to provide for any handwritten notes to be translated into typed text or stored as handwritten notes via digital-ink technology. As used herein, the term digital-ink technology should be broadly construed to refer to technology that digitally represents handwriting in its natural form. In general, in a typical digital-ink system, a digitizer is laid over a liquid crystal display (LCD) screen to create an electromagnetic field that can capture the movement of a stylus and record the movement on an LCD screen. The recorded handwriting can be saved as handwriting or converted to type written text if handwriting recognition technology is employed.

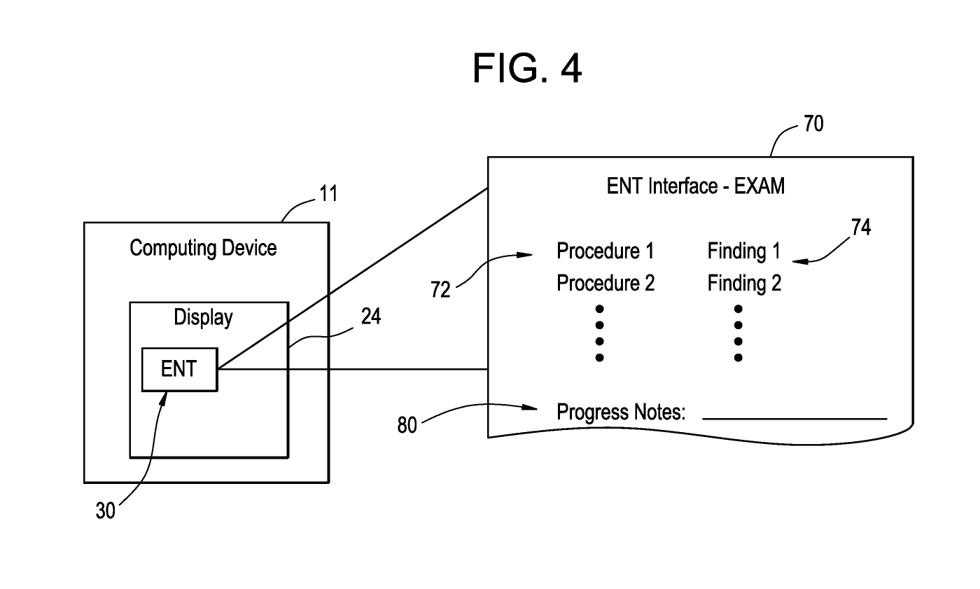

The above-described computer implemented method has thus far been described in connection with a patient interview (e.g., performance of Step 104). Similarly, once an interview has been conducted, an examination step (Step 106 of FIG. 2) may follow. As with the patient interview, the health care provider can use the system 10 and the computing device 11 to memorialize findings made during the examination step. As the examination progresses, or subsequent thereto, the health care provider can enter the findings. For example, referring again to an ear examination, the health care provider during the course of the examination can initially be presented with an ENT interface—Exam 70 (FIG. 4) providing a plurality or series of choices 72 including, for example, one or more steps or procedures, evaluations and/or tests, and the like. The plurality of choices 72 may include one or more findings 74 corresponding to the choices 72 made and may result in the health care provider being presented with still further series of choices. As with the above-described patient interview, the health care provider can continue to be presented with choices until such time as the examination is concluded.

During the above-described processes (e.g., using the interview interface 32 and examination interface 70), the computing device 11 is operable to allow the health care provider to digitally record progress notes 80. The progress notes 80 can take the form of one or more of typed text, in an embodiment where the computing device 11 is a tablet type computer having a tablet screen and some PDA's that can accommodate it, written text, ink technology, video recordings, audio recordings, and combinations thereof. The computing device 11 can also be operable to provide for any handwritten notes to be translated into typed text or stored as handwritten notes via digital-ink technology.

Once the interview is finished and/or the examination concluded, the health care provider can enter a disposition (Step 108 of FIG. 2). Depending on the findings made, or the results of the interview, the disposition can take one of several forms. For example, a referral to a specialist may be necessary, certain tests or therapies may be required, medication may be needed, and/or follow-up visits. Again, the computing device 11 is operable to allow for the entry of typed, in some instances handwritten, and/or recorded (audio and/or video) progress notes.

Prior to a patient interview and/or examination, the computing device 11 can be operable to cause patient identifying information (e.g., name, address, date of birth, and the like) to be associated with the information recorded by the health care provider in the interview and examination steps, Steps 102 and 104, respectively. As shown in FIG. 1, the digital progress notes 80, the patient data and information and the data and information gathered and/or inputted during the interview and/or examination steps, may be stored in the data storage device 52, e.g., as the information 54, and may be accessible by a server or other computer having software sufficient thereon to allow for access to the data storage device 52. As should be appreciated, the server can be resident within, for example, an office and be accessible over an intranet, or the server can be remotely located and be accessible over using a virtual private network or similar type of connection. In one embodiment, the PA methods 14A are web-based and employ the internet to provide access thereto. Access can be attained via a website accessible using the computing device 11 or a similar standalone or networked communications device.

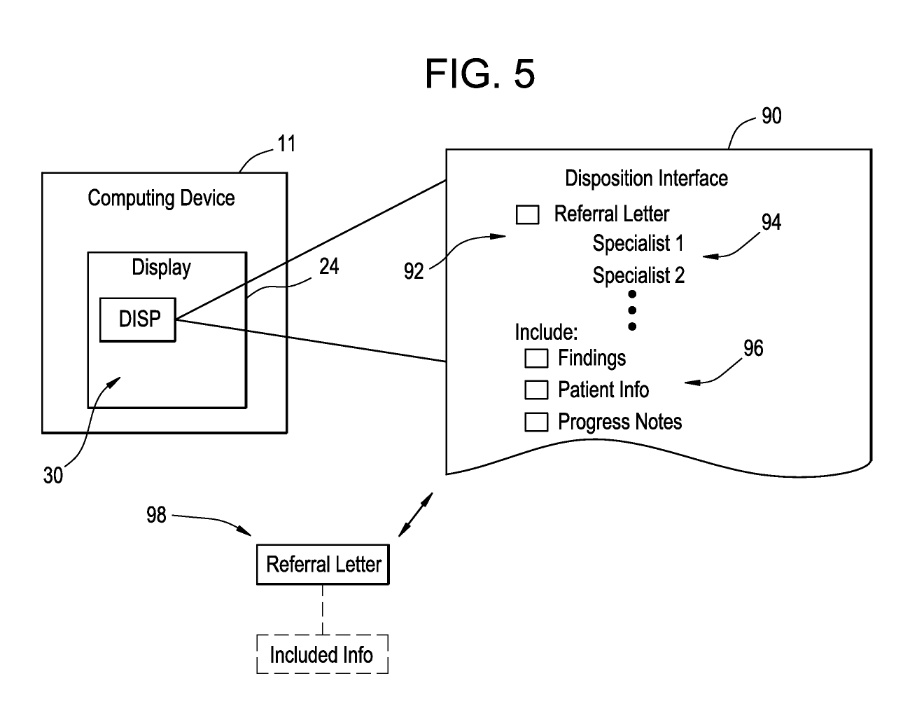

Once the interview and/or examination has been concluded and a disposition decided upon, the health care provider can use the information system 10, e.g., the computing device 11, to invoke a disposition interface 90 (FIG. 5) to automatically generate one or more form-type letters 98 that incorporate all or a portion of the information ascertained during the interview and/or examination. For example, if it is determined that the patient needs to be referred to a specialist, the health care provider selects (at 92) that a referral letter should be generated. The health care provider can select the type of letter to be created and then can select from a predetermined list, or type the entity's name to which the referral is being made (e.g., selected one or more specialists from a list of specialists 94). In one embodiment, the health care provider may select (e.g., in list 96) information to be included with the referral letter. For example, the digital progress notes can be part of the referral. The type of letter generated, and/or whether included information is sent, may also determine which information should be included. The form letters can be e-mailed from the communications device, printed, faxed, and sent to secretarial personnel for printing and mailing, or combinations thereof.

As should be appreciated from the above-described examples, the information system 10 can be customizable by the user/health care provider. For example, the health care provider can enter the items, e.g., symptom menus, list, and the like, within the interfaces 32, 70, 90, that are accessible during an interview, examination and/or disposition steps 104, 106, 108 respectively, and can also enter the questions to be answered depending on the choices made by the user of the communications device. The health care provider or other personnel can also determine the answers from which the health care provider using the computing device 11 can choose from.

The above-described form letters can also be customized by the user or other person to input predetermined text depending on the choices made by the user of the communications device in answering the questions presented thereby. Accordingly, a user can create diagnostic symptoms lists and related questions as well as predetermined text to be input into form letters generated as a result of the responses to the choices made from the symptoms lists and related questions. Where necessary, the progress notes input by the user of the computing device 11 can also be part of the form letters. This option can be given to the user at the time of generating the form letter.

The interfaces 32, 70 and 90, because of the manner by which a user can determine what is exhibited on the display 24 of the computing device 11, can be easily modified or the questions and/or symptoms list updated as new information becomes available. In this manner a medical or other type of office can be run consistently and with dramatically improved efficiencies.

The present invention also resides in a computer implemented method for quickly and efficiently, within an electronic medical record system, entering information required by an EMR certifying authority related to individual patients. The information required by the certifying authority is programmed into the computing device 11 so that the information can be displayed thereon. During a patient interview wherein the above-described information is being entered by a health care provider or by the patient (hereinafter referred to as the “user”) the user selects a category displayed in the computing device 11 such as for example, general information. The user is then presented with one or more selectable items such as, but not limited to, “Does the patient smoke,” or “has the patient recently lost weight.” Choosing one of these items then results in additional selectable items being displayed by the computing device 11. Then additional items are presented to the user with choices to select from based on answers elicited from the patient. For example, in response to selecting, “Does the patient smoke” the user could be presented with selectable item indicating a “yes” or “no” response. If “no” is selected then the user can move on to the next category of information such as, for example, “has the patient recently lost weight.” If the item indicating “yes” is selected then another series of selectable items indicative of a patient's response may be displayed. For example, selectable items indicating the number of packs of cigarettes a patient smokes per day may be displayed. Once selected, the information corresponding to the selected item is stored in the patient's medical records (e.g., in the information 54 of the data storage device 52). The information system 10 can also provide for a user to add notes to further describe or clarify a selection. These notes can be typed into the computing device 11, written by hand such as would be done using an electronic tablet, or tablet-type P.C. The notes may also be recorded and stored by the computing device 11 into the data storage device 52. Where the computing device 11 is a tablet or tablet-type P.C., a scrolling feature is integrated into the interfaces 32, 70 and 90 to allow the selectable information to be scrolled through quickly using a system, touch pad, or a user's finger.

The exemplary information referred to above should not be considered an exhaustive listing as there are a myriad of different information types that can be required by the certifying authority. The digital decision tree described above allows the user to rapidly input acquired information thereby allowing for more time to be spent by the health care provider with the patient.

Although this invention has been shown and described with respect to the detailed embodiments thereof, it will be understood by those of skill in the art that various changes may be made and equivalents may be substituted for elements and steps thereof without departing from the scope of the invention. In addition, modifications may be made to adapt a particular situation to the teachings of the invention without departing from the essential scope thereof. Therefore, it is intended that the invention not be limited to the particular embodiments disclosed in the above detailed description, but that the invention will include all embodiments falling within the scope of the above description.

What is claimed is:

1. A computer implemented method for digitally recording progress notes, the method comprising:
providing a content database operable with a computing device, said content database being populable with identifying information relevant to patients and care providers;
the computing being operable by a user such that the user selects items exhibited on a display of the computing device; and
the computing device being operable to generate information mandated by one or more certifying authorities by causing questions pertaining to the mandated information and selectable answers to the questions to be exhibited on the display, at least a portion of the questions displayed being dependent on the answers chosen by a user during operation of the computing device; and
receiving the answers into the content database.

2. A method as defined by claim 1 wherein the computing device is one of a desktop computer, a laptop computer, a tablet computer, and a PDA.

3. A method as defined by claim 1 wherein the computing device is operable with the content database to allow a user to manually enter the progress notes into the computing device.

4. A method as defined by claim 3 wherein the computing device includes a tablet screen and the tablet screen is operable such that via digital-ink technology a user can handwrite the progress notes onto the tablet screen.

5. A method as defined by claim 4 wherein the progress notes are stored in the content database as handwriting.

6. A method as defined by claim 5 wherein the computing device is operable to convert the progress notes into typed text.

7. A method as defined by claim 1 wherein the computing device is operable to allow a user to quickly scroll through information shown on the display.
